(19) United States
(12) Patent Application Publication
(10) Pub. No.: US 2007/0214498 A1
(43) Pub. Date: Sep. 13, 2007

(54) Method for Transmitting Secured Contents Over the Internet

(75) Inventors: Marius Pindra, Paris (FR); Stephane Prevost, Lille (FR); Thierry Piolatto, Paris (FR)

Correspondence Address: YOUNG & THOMPSON, 745 SOUTH 23RD STREET, 2ND FLOOR, ARLINGTON, VA, 22202, US

(73) Assignee: GLOBAL INTERFACE, PARIS (FR)

(21) Appl. No.: 11/578,662

(22) PCT Filed: Apr. 19, 2005
(86) PCT No.: PCT/FR05/00959

§ 371 Date: Oct. 18, 2006

(30) Foreign Application Priority Data
Apr. 19, 2004 (FR) 04 04123

(51) Int. Cl. H04L 12/22

(52) U.S. Cl. 726/4; 726/5

(57) ABSTRACT

Method for securely transmitting a content via an Internet communications network includes: opening a web page containing at least one encrypted content via the computer navigator of a user, activating an applet/application which is loaded with the web page and requests the user's identification, recording the user identifier, transmitting the user identifier to an authentication server via the applet, in case of the authentication, transmitting a licence from a matching server to the applet, displaying a view window, decoding the content in the web page according to the licence and displaying the decrypted content on the view window in response to a display instruction.

This invention relates to a method for securely transmitting at least one content via an internet communications network.

It has a particularly useful application in the field of the syndication of electronic contents. The contents can be “news”, articles, etc. The syndication of contents consists in distributing publication data stored in a database of a publication server, a sort of content wholesaler. The distribution is carried out from a server either by FTP or by mail (attachment). The client receives syndicated contents in text, HTML or XML format. The client offers these contents to individuals over the internet.

However, the invention has a broader scope as it can be applied to any system for transmitting contents over the internet.

In order to allow only suitably subscribed users to consult the appropriate contents it is necessary to make the transmission of the contents secure.

The purpose of this invention is therefore a novel method making it possible to limit the transmission of contents on a web page to predefined users.

The purpose of the invention is to make the contents available on the internet secure.

The desired purpose is achieved with a method for securely transmitting at least one content via an internet communications network. According to the invention the following steps are carried out:
opening, by means of the user's computer browser, a web page containing at least one encrypted content, this content can be encrypted in a conventional manner such as for example symmetric encryption;
activating an application, called an applet, which is embedded in said web page, this applet requesting the user's identification;
recording an identifier of the user; in particular the user enters his login and his password in an composition window created by the applet, however it can also be envisaged that the applet automatically retrieves the user identifier stored in the computer;
sending, by means of the applet, the user identifier to an authentication server;
in the case of authentication, sending a licence from an accreditation server to the applet;
displaying a viewing window; and
decrypting said content present in said web page according to the licence and displaying this decrypted content in the viewing window in response to a display instruction. This instruction can be given by a user clicking on a heading, this heading being a hypertext link displayed in the viewing window.

The applet is preferably a java module but can also be an embedded module developed in C++ or any other language.

Moreover, using the RSS standard, it is possible to envisage a single page integrating both the web page and the viewing window. RSS stands for “Rich Site Summary” and corresponds to a content of a web site described in XML according to the RDF or “Resource Description Framework” format.

According to one embodiment of the invention, the licence comprises content use parameters, constraint parameters and a decryption key.

The use parameters can be use rights making it possible to define the possibility or otherwise of viewing, copying, printing or redistributing the content. The constraint parameters can be constraints on use such as the content is valid for one week, once only, etc.

Advantageously, the encryption key is stored only in the random access memory of the computer. In fact, the whole of the licence remains in the random access memory so that no confidential information remains in the user's computer indefinitely.

Preferably the applet sends at the same time as the user identifier, the identifier of each content present in said web page. It is thus possible to more precisely associate a corresponding licence with each content.

According to the invention, as long as the viewing window is active, the applet records a set of consultation data. This data is for example the number of times that the user has printed the content.

According to an advantageous characteristic of the invention, when the viewing window is closed, the applet sends back to the accreditation server, the licence updated using said set of consultation data.

Other advantages and characteristics of the invention will become apparent on examining the detailed description of an embodiment which is in no way limitative and the attached drawings in which:

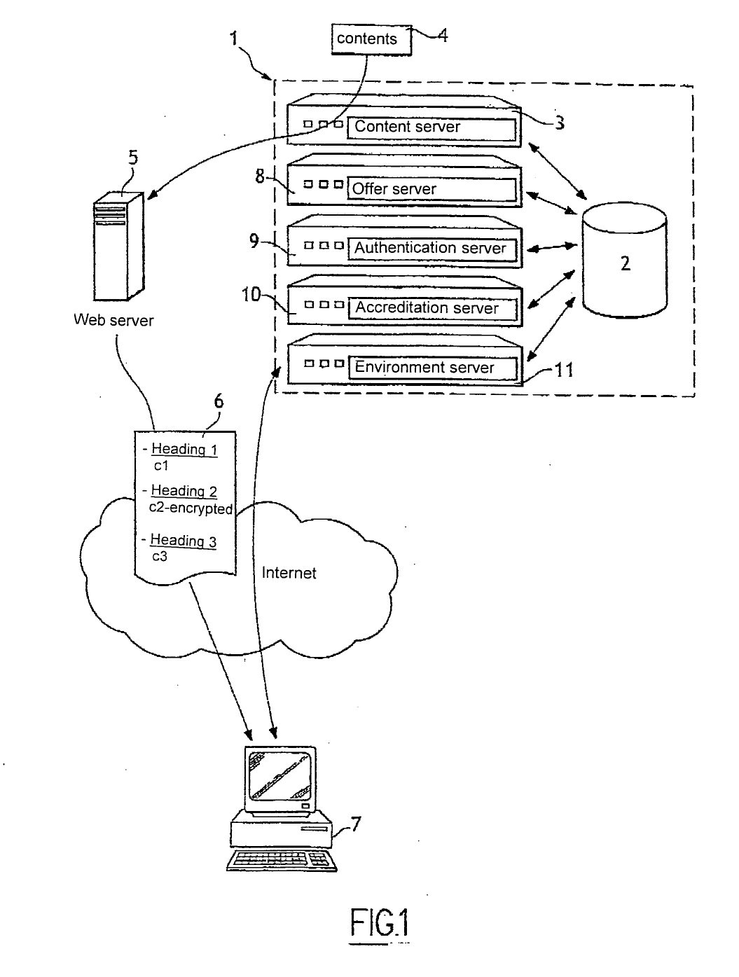

FIG. 1 is a general diagrammatic view of a system using the method according to the invention;

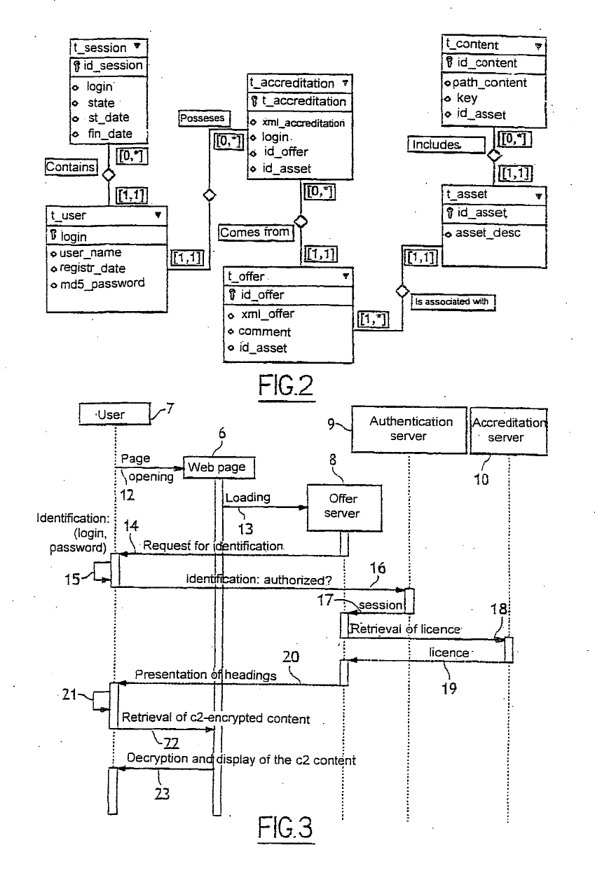

FIG. 2 is a diagram illustrating the architecture of the database represented in FIG. 1;

FIG. 3 is a flow chart illustrating different steps of the method according to the invention; and

FIG. 4 is a diagrammatic view of a web page and a window for inputting an identifier according to the invention; and

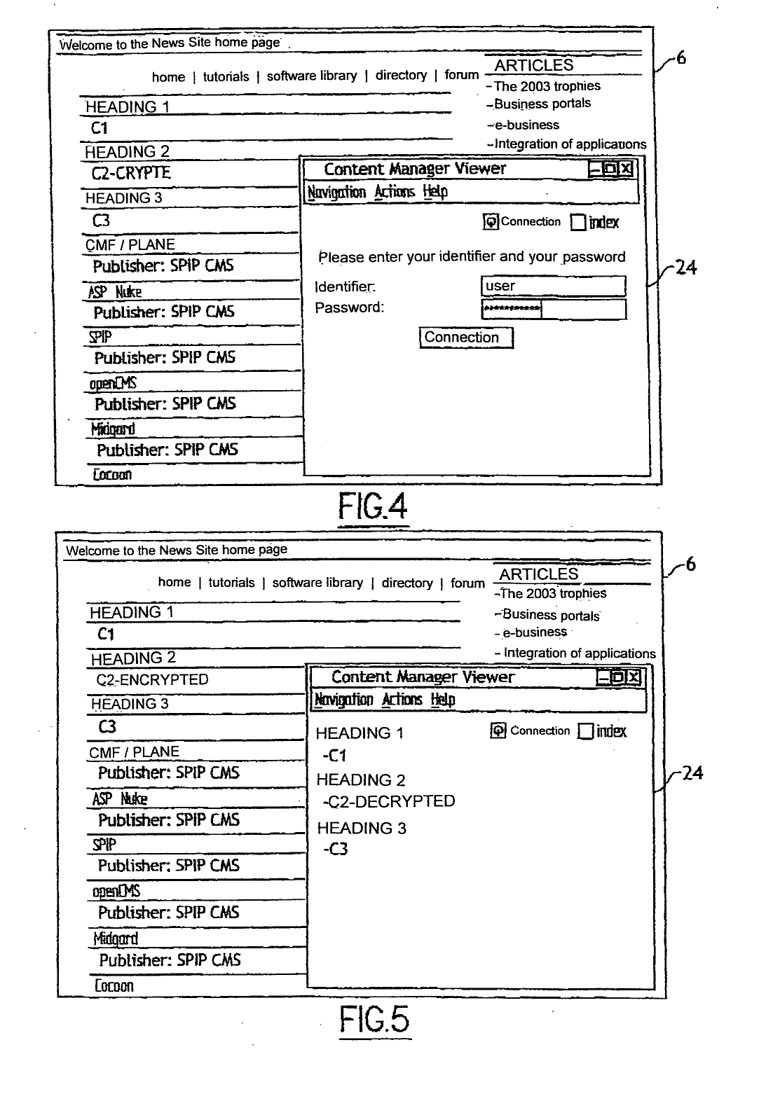

FIG. 5 is a diagrammatic view of a viewing window and a web page according to the invention.

FIG. 1 shows a platform 1 which is accessible over the internet and offering a set of services. It comprises a content server 3 which is able to encrypt contents 4 coming from an external medium and send them to a web server 5 for consultation over the internet. This web server 5 is able to transmit any sort of contents, encrypted or not. The encrypted contents can be mixed with non-encrypted contents and transmitted over the internet within a web page 6 to the computer 7 of a user. In order to decrypt the encrypted contents, the user must contact the platform 1 in order to retrieve decryption rights. Preferably, the user will have taken the time to register with the platform 1 beforehand. In this platform 1, the database 2 is connected to a plurality of web service servers:
the function of the offer server 8 is to present the user with various subscription possibilities, i.e. various licence levels; it therefore allows the user to subscribe;
the function of the authentication server 9 is to manage the registration and authentication of the users,
the function of the accreditation server 10 is to manage the licences,
the function of the environment server 11 is to update the licences upon receipt of the information sent by the applet module when the session is finished.

FIG. 2 shows in a little more detail the structure of the database 2 constituted by at least six tables:
t_user is a table containing the registered users;
t_session: a session is begun each time a user identifies himself;
t_content is a table referencing the contents;
t_asset: an asset corresponds to a given type of contents such as the week's lead articles or also all the sports news, etc . . .
t_offer: an offer is a set of authorizations associated with an asset;
t_accreditation: an accreditation is a licence and corresponds to the subscription of a user to an offer.

The various tables are concatenated in series so as to constitute a solid base. Preferably, the offers and the accreditations are written in ODRL language or “Open Description Right Language”.

According to FIGS. 1, 3, 4 and 5, a method for consulting encrypted contents according to the invention will now be described. The web server 5 has previously stored a c2-encrypted content downloaded from the content server 3 of the platform 1. In FIG. 3, the user 7 downloads in step 12 a web page 6 containing two non-encrypted contents c1, c2, a c2-encrypted encrypted content as well as each heading associated with each content, heading1, heading2, and heading3. The contents c1 and c2 can be represented on the web page in the form of readable texts while the c2-encrypted content is an incomprehensible encrypted text. Advantageously, this web page 6 comprises an embedded application such as a java module (applet) which, as soon as this web page 6 is displayed, activates in step 13 the offer server 8 which sends a query to the client to the client 7 in step 14. This query corresponds to a request for identification. The user identifies himself in step 15 by entering for example a login and a password. FIG. 4 shows the web page 6 as well as a window of the “popup” type 24 produced with the java module so as to send to the platform 1 the identifier of the user as well as the identifier of the c2-encrypted content. The response of the user 7 is sent directly to the authentication server 9 during step 16. The latter begins a session in step 17 such that the offer server 8 retrieves, during steps 18 and 19, from the accreditation server 10, a licence associated with this user. This licence is specific to the c2-encrypted content. This licence describes a right of use which can be the right to view without the possibility of copying, printing or redistributing. The licence also describes a constraint on use which is for example a possible viewing for one week starting from the first viewing. It also comprises a key for decryption of the c2-encrypted content.

In step 20, the offer server 8 sends the recorded licence to the java module embedded in the web page 6. This licence remains stored in the random access memory of the computer of the user 7. The embedded module then creates a viewing window 25 as seen in FIG. 5. This window 25 catalogues all of the headings, the contents of which are present in the web page 6, therefore within the computer of the user 7. When, during step 21, the user clicks on the heading2 in order to view the c2 content, the java module retrieves in step 22 the c2-encrypted content within the web page 6, transforms it into c2-decrypted content using the decryption key present in the licence and displays this c2-decrypted content in the viewing window 25 during step 23.

The actions which the user may carry out in the viewing window are managed by the java module as a function of the use rights associated with the licence.

When the viewing window 25 is closed, the java module updates the licence as a function of the user's actions and sends said licence to the accreditation server. Alternatively, the java module can send the licence and the actions directly to the platform 1, this is the environment server which will take charge of updating the licence.

In a general manner, each server (contents, offers, authentication, accreditations and environment) is a web server which can be activated either by the applet or by a user action.

Of course, the invention is not limited to the examples which have just been described and numerous adjustments can be made to these examples without exceeding the scope of the invention.

1. Method for securely transmitting at least one content over an internet communications network, characterized in that it comprises the following steps:
opening, by means of the browser of the computer of a user, a web page containing at least one encrypted content,
activating an application, called an applet, which is embedded in said web page, this applet requesting the user's identification;
recording an identifier of the user;
sending, by means of the applet, the user identifier to an authentication server;
in the case of authentication, sending a licence from an accreditation server to the applet;
displaying a viewing window;
decrypting said content present in said web page according to the licence and displaying this decrypted content in the viewing window in response to a display instruction.

2. Method according to claim 1, characterized in that the licence comprises content use parameters, constraint parameters and a decryption key.

3. Method according to claim 2, characterized in that the encryption key is stored only in the random access memory of the computer.

4. Method according to claim 1, characterized in that the applet sends at the same time as the user identifier, the identifier of each content present in said web page.

5. Method according to claim 1, characterized in that as long as the viewing window is active, the applet records a set of consultation information.

6. Method according to claim 5, characterized in that when the viewing window is closed, the applet sends back to the accreditation server the licence updated using said set of consultation data.

7. Method according to claim 2, characterized in that the applet sends at the same time as the user identifier, the identifier of each content present in said web page.

8. Method according to claim 3, characterized in that the applet sends at the same time as the user identifier, the identifier of each content present in said web page.

9. Method according to claim 2, characterized in that as long as the viewing window is active, the applet records a set of consultation information.

10. Method according to claim 3, characterized in that as long as the viewing window is active, the applet records a set of consultation information.

11. Method according to claim 4, characterized in that as long as the viewing window is active, the applet records a set of consultation information.
